(19) United States
(12) Patent Application Publication
(10) Pub. No.: US 2012/0080450 A1
(43) Pub. Date: Apr. 5, 2012

(54) FOOD DISPENSER

(75) Inventors: Mark Dieter DZIERSK, Winnetka, IL (US); James A. SHOEMAKER, Chicago, IL (US); Olivier Franck CURRAT, Chicago, IL (US); Harry BOER, Rotterdam (NL)

(73) Assignee: CONOPCO, INC., D/B/A UNILEVER, Englewood Cliffs, NJ (US)

(21) Appl. No.: 12/896,298

(22) Filed: Oct. 1, 2010

(51) Int. Cl. B67D 7/84; B65D 37/00; B65D 35/38

(52) U.S. Cl. 222/173; 222/212; 222/494

(57) ABSTRACT

A food dispenser comprise a flexible container with a spout member at the bottom end thereof. The bottom end of the container is supported by means of a cap stand which surrounds the spout member. The cap stand has a cap for closing or opening the dispenser in view of discharging a fluid food product. Because the cap stand has a collar which is at least partly transparent, the spout member as well as the discharge of the food product from the spout member can be readily observed by the consumer. Thereby, the consumer may control the dosing of the food product from the dispenser in a better way.

The invention is related to the field of food dispensers of the bottom opening type. The invention is specifically related to a bottom opening dispenser which comprises a squeeze container holding a viscous food product and a cap stand by means of which the dispenser can be positioned according to an inverted posture, with the discharge spout pointing downwards. The container is squeezable, in such a way that the contents can be expelled by exerting a pressure on the container.

The cap stand of the present dispenser comprises a collar located around the spout, a cap and a hinge that connects said cap to said collar, wherein at least a part of said collar is transparent.

### BACKGROUND OF THE INVENTION

Dispensers of the bottom opening type are positioned with the discharge opening pointing downwards. Such design has several advantages over the other type of dispensers, the so-called top opening dispensers. For instance, the contents of the bottom opening dispenser are held near the discharge opening under the influence of gravity, which has the advantage that the dispenser can be emptied almost completely. Moreover, the viscosity of a viscous food product such as ketchup, mustard, mayonnaise and the like will not hamper the discharge because the contents are readily available for dispensing.

Reference is made to the food dispenser as disclosed in U.S. Pat. No. 5,460,298, comprising a transparent stand which is detachably connected to the container thereof. Said container has a bottom opening which is closed by means of a separate screw cap or click cap. The stand itself does not have a cap.

The dispenser for liquid detergents according to EP-A-391688 has a cover cap, the purpose of which is to dose a predetermined quantity of detergent therein. The dispenser may be positioned upside down on said cap. The cap is not carried out as a cap stand having a collar and an openable cap or lid, nor has a spout been provided.

WO-A-2007/130563 is related to a bottom opening dispenser for gel compositions. The dispenser has a transparent dispensing cap for supporting the dispenser. There is no cap stand having a collar and a lid or cap which can be opened or closed.

### SUMMARY OF THE INVENTION

The cap stand of dispensers of the bottom opening type provides a stable position of the dispenser on a surface, such as a shelf or table. In this connection, the cap stand usually has considerable cross dimensions which allow the stable position to be obtained. As a result of the considerable dimensions of the collar however, the view on the spout is hampered. The consumer, while using the food dispenser for applying the food product, lacks therefore proper control over the discharge of said product. This may result in an uncontrolled release of the food product, in particular in case the container is squeezed too strongly.

The object of the invention is therefore to provide a food dispenser which allows an improved control of the discharge of the product in question from the container. This object is achieved by means of a food dispenser comprising:
a squeeze container holding a viscous food product, said squeeze container comprising a bottom opening;
a spout member connected to the lower end of the container over the bottom opening thereof, said spout member having a spout opening through which the viscous food product is discharged;
a cap stand comprising a collar located around the spout member, a cap and a hinge that connects said cap to said collar, said cap stand being transferrable between a closed position in which the spout opening and the cap are closed, and an open position in which the spout opening and the cap are open for discharge of the viscous product, said cap having a foot so that a stable support is provided for the dispenser in the closed position of the cap;
   wherein at least a part of said collar is transparent so that a user can observe said discharge of fluid food product from the spout.

In the food dispenser according to the invention, the stable support of the dispenser in inverted position is still obtained by the cap stand. However, as at least part of the collar of the cap is transparent, the spout member may be observed by the consumer and thus also the amount of food product which emanates from the spout. The cap may be transparent as well. The spout member protrudes from the container into the cap stand, whereby good visibility of the spout member is obtained. As a result, the consumer is now in a position to better control the amount of food product which is discharged from the container through the free opening of the spout member. In particular, the consumer is able to squeeze the container in a better controlled way so as to obtain the desired amount of food product.

### DRAWINGS

FIG. 1 shows a view in perspective of the lower part of the food dispenser in closed condition.

FIG. 2 shows the lower part of the food dispenser in open position.

FIG. 3 shows a side view of the open food dispenser.

FIG. 4 shows a section through the cap stand.

FIG. 5 shows a bottom view of the cap stand with dimensional details.

FIG. 6 shows a further embodiment of the cap stand.

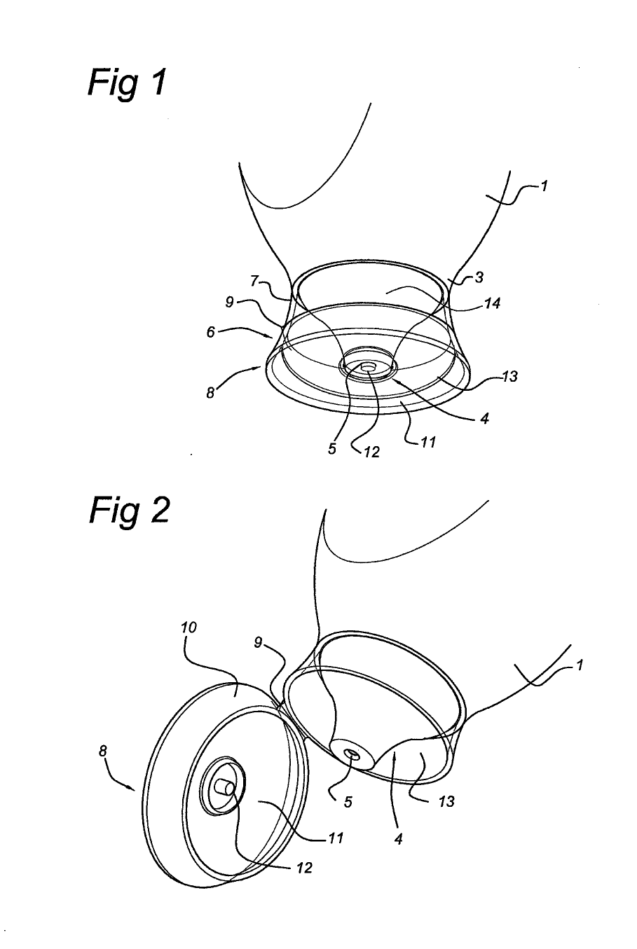

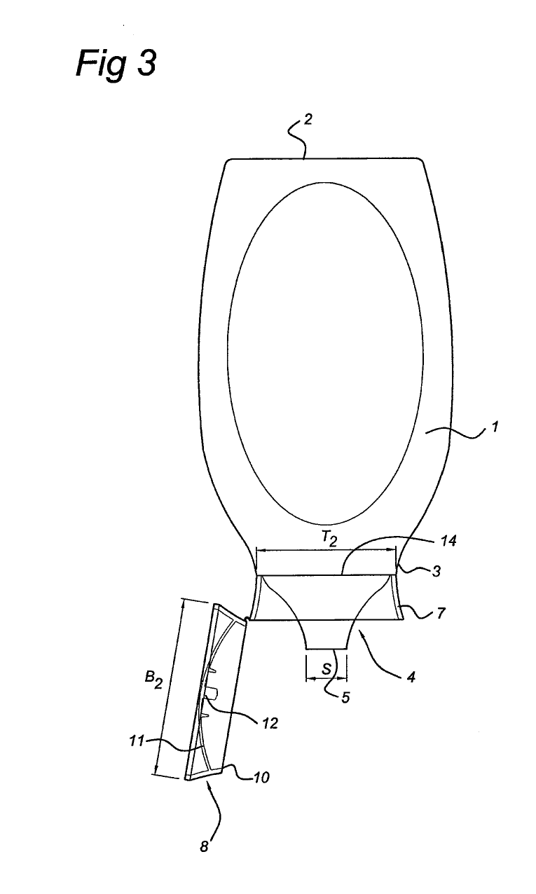

### DETAILED DESCRIPTION OF THE INVENTION

Accordingly, the present invention provides a food dispenser comprising:
a squeeze container holding a viscous food product, said squeeze container comprising a bottom opening;
a spout member connected to the lower end of the container over the bottom opening thereof, said spout member having a spout opening through which the viscous food product is discharged;
a cap stand comprising a collar located around the spout member, a cap and a hinge that connects said cap to said collar, said cap stand being transferrable between a closed position in which the spout opening and the cap are closed, and an open position in which the spout opening and the cap are open for discharge of the viscous product, said cap having a foot so that a stable support is provided for the dispenser in the closed position of the cap;
   wherein at least a part of said collar is transparent so that a user can observe said discharge of fluid food product from the spout.

Usually, an annular chamber is defined between the spout member and the collar. The spout member is thus clearly visible within the annular chamber, whereby the egress of the food product is easily observed. For instance, a proper chamber is obtained in case the internal diameter of the bottom end of the collar is at least 2 times larger than the external diameter of the bottom end of the spout member. The spout member itself may be transparent or translucent, although preference is given to a non-transparent spout member. Similarly, the container may be either transparent or non-transparent.

The collar may be partly transparent; for instance, at least 50% of the collar may be transparent. Preferably, at least 80% of the collar is transparent, more preferably at least 90% of the collar is transparent and most preferably the complete collar is transparent.

In accordance with another preferred embodiment, the cap stand, including collar, cap and hinge, is transparent,

In order to enable careful dosing of the viscous food product that is contained within the squeeze container the spout opening preferably has an internal diameter of less than 1 cm, even more preferably of less than 6 mm, most preferably of less than 4 mm. Typically, the spout opening has a diameter of at least 0.3 mm, even more preferably of at least 0.5 mm.

After the food dispenser has been used several times, tiny rests of the food product might adhere to the outside of the spout opening. Such tiny amounts usually do not detract from the overall appearance of the food dispenser. However, it would be quite undesirable in case such amounts would drip further into the chamber and along the outside of the spout member, for instance as a result of an inverted position of the food dispenser. For the purpose of preventing such dripping to occur, a shield may provided within the annular chamber. This shield extends between the outside of the spout member and the inside of the collar, in such a way that possible drippings are prevented from entering the chamber. The shield may be located at the lowermost end of the collar and the spout, so as to achieve a maximal effect. Preferably, the shield is transparent as well.

The container may comprise a neck surrounding the bottom opening thereof, in such a way that spout member and/or the collar may be detachably connected to the neck, e.g. by means of a screw connection. The cap stand may be connected to the container according to several possibilities. Preferably, the cap stand is connected to the spout member, such as by molding. The cap stand may be formed in one piece, such as by injection molding. Alternatively, the cap stand may be assembled from distinct parts, e.g. by gluing, welding and the like.

The quality of the food product in the flexible container can be guaranteed by providing the bottom opening with a releasable seal. The consumer removes this seal before use; to that end, the cap stand comprising the spout and cap can be removed from the container. After the seal has been released, the cap stand is put back on the flexible container.

The cap stand may have any shape, for instance a cylindrical shape. In particular, the cap stand may have a non-cylindrical shape defined by mutually perpendicular top width dimensions T1, T2 and mutually perpendicular bottom width dimensions B1, B2, at least one of said top width dimensions being smaller than a corresponding one of said bottom width dimensions. The relatively wide bottom end of the cap stand and the correspondingly wide support face of the cap provide a stable support of the dispenser. Preferably, the ratio of a bottom width dimension B1, B2 to a corresponding top width dimension T1, T2 is in the range of 2:1 to 1.1:1. In case the top and bottom of the cap stand are circular (B1=B2, respectively T1=T2), the ratio of the top diameter and of the bottom diameter may be in the same range of 2:1 to 1.1:1. Alternatively, the bottom of the cap stand may also have a non-circular shape, such as oval or elliptical. Also, the top of the cap stand may have a non-circular shape, e.g. an oval shape or elliptical shape etc. The ratio of a bottom width dimension B1, B2 to height dimension H of the cap stand may be in the range of 1:1 to 3:1.

The collar may have similar shapes as well. The top end of the collar may be narrower than the bottom end thereof. Also, the collar may have a circular or non-circular top end and bottom end.

For the purpose of providing a proper connection between the cap, in the closed position thereof, and the collar, the cap may comprise an annular flange or rim that engages the bottom end of the collar in the closed position of the cap. Furthermore, the cap may comprise a stop that engages the spout opening in the closed position of said cap. The spout is thus closed as soon as the cap is transferred to the closed position.

The food dispenser is preferably manufactured from a plastics material. In particular, the cap stand and the spout member consist of plastic material. The expression “transparent” as used before refers to the light transferring capacity of the material from which the collar has been manufactured. It will be understood that the best result for viewing the discharge of the food product is obtained in case said material is highly transparent. As an example, the cap stand material may transmit at least 60% or even at least 80% of the incident light. More preferably, at least 90% of the incident light is transmitted, even more preferably at least 95% of the incident light is transmitted and most preferable at least 99% of the incident light is transmitted.

It is pointed out that the bottom opening dispenser as discussed before may have text and image imprints on the outside thereof for customer information. Such imprints will be readily discernible in case the dispenser is oriented according to the nominal position with the bottom opening pointing downward. However, it is not excluded that the dispenser may also be oriented with the bottom opening pointing upward, for instance during transport or even in store or on display at the location of the retailer.

The viscous food product comprised by the squeeze container typically has a viscosity at 20° C. and a shear rate of 10 s⁻¹ of at least 1.0 Pa.s. More preferably, the food product has viscosity under these conditions of at least 5.0 Pa.s, even more preferably of at least 8.0 Pa.s and most preferably of at least 10.0 Pa.s. Examples of viscous food products that may advantageously be packaged in the present dispenser include mayonnaise, ketchup and mustard.

The invention will now be described further with reference to the embodiment of the food dispenser as shown in the drawings.

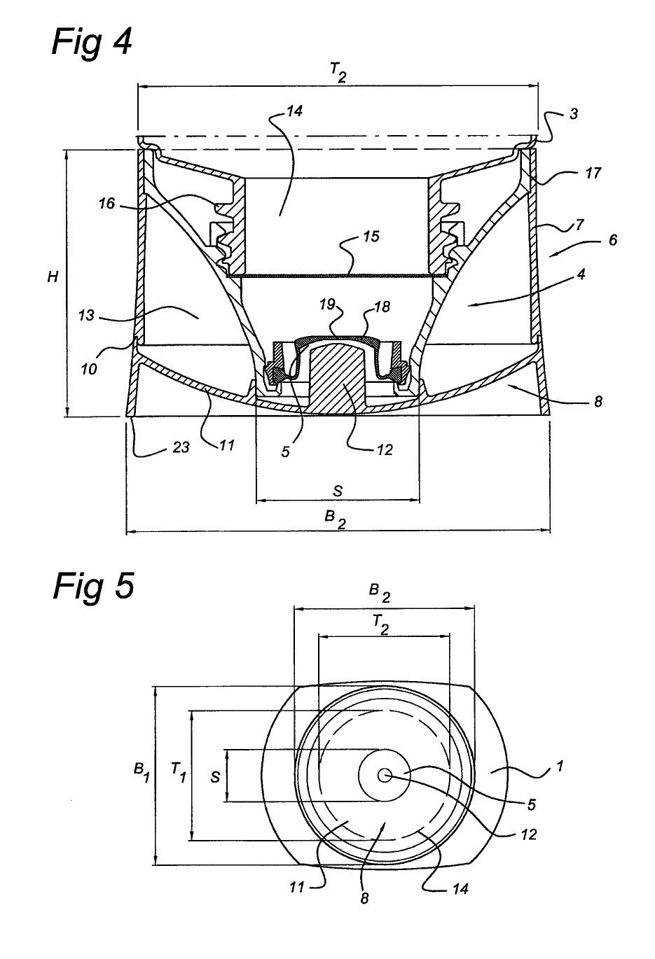

The food dispenser as shown in the figures comprises a squeeze container 1, preferably of a flexible plastic material, which has an upper wall 2 and a container neck 3 at the lower end. Onto the neck 3, a spout member 4 is mounted by means of screw threads 16 as shown in the section of FIG. 4. Said spout member 4 has a through going channel which at the upper end connects to an opening 14 in the container neck 3 and which at the lower end has a spout opening 5. As shown in FIG. 4, a plastic valve 18, e.g. from silicone, is applied on the spout opening 5. The valve 18 has a slit 19, which may be carried out as a cross shaped slit, through which the food product is discharged.

A cap stand 6 is provided around the spout member 4. This cap stand 6 is transparent and consists of the collar 7 and the cap 8. The collar 7 has an upper end which is connected to the spout member 4 through the mould seam 17, and a lower end. The spout member 4 protrudes downwardly into the cap stand 6, and in particular into the collar 7 thereof. By means of the elastic hinge 9, the cap 8 is suspended from the lower end of the collar 7. The cap 8 has a cap wall 11 and an upper circumferential rim 10, which, in the closed position of the cap 8, engages the lower end of the collar 7, e.g. by a click or snap fit connection. The lower circumferential rim 23 of the cap forms a flat support of the dispenser, in the closed condition of the cap 8.

Furthermore, the cap has a stop 12 at its inner surface. In the closed position of the cap 8, said stop 12 engages the spout opening 5 of the spout member 6 so as to close the spout member and prevent the egress of the food product from the container.

At the free end of the neck 3, a seal 15 has been applied for protection of the food product (not shown) in the container 1 against quality loss, tampering etc. Before use, the seal has to be removed from the neck. To that end, the cap stand 6 together with the spout member 4 are unscrewed from the neck 3; after removal of the seal, the cap stand and spout member 4 are refitted onto the neck 3.

A chamber 13 is defined between the spout member 4 and the collar 7. Through the transparent material of the collar 7, the consumer may easily observe the spout member 4 and the food product which is discharged from the spout member 4, thereby enabling a better control of the dispensing function.

The cap stand may be carried out in several shapes. The cap stand may for instance have a non-circular shape, with mutually perpendicular top dimensions T1 and T2 which are different from each other. Thus, the top may be for instance elliptical or oval and the like. Alternatively, the top dimensions T1 and T2 may be equal, such that the top of the cap stand is circular (see FIG. 5). Furthermore, the mutually perpendicular bottom dimensions B1 and B2 may be different, for instance elliptical or oval and the like, or equal. The collar 7, as part of the cap stand 6, may have corresponding circular or non-circular shapes at its top end and bottom end as well. Furthermore, the top end of the collar may be narrower than the bottom end thereof.

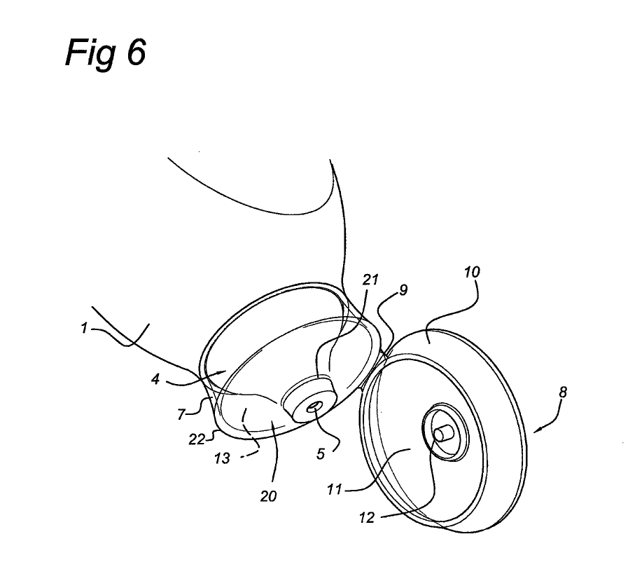

In the embodiment of FIG. 6, a transparent shield 20 stretches between the spout member 4 and the collar 7. The outer boundary 22 of the shield 20 adjoins the inside of the collar 7, and the inner boundary 21 of the shield 20 adjoins the outside of the spout member 4. Any drippings which might be collected near the spout opening 5 are thus prevented from entering the chamber 13 between the spout member 4 and the collar 7. Thus, the overall appearance of the food dispenser will not be spoiled by rests of the food product which adhere to the outside of the spout member. In particular in case the spout member 4 is non transparent, the drippings will hardly be noticed near the spout opening 5.

1. A food dispenser comprising:
a squeeze container holding a viscous food product, said squeeze container having a bottom opening;
a spout member connected to the container over the bottom opening thereof, said spout member having a spout opening through which the viscous food product is discharged;
a cap stand comprising a collar which is located around the spout member and which is connected to the container and/or the spout member, a cap and a hinge that connects said cap to said collar, said cap stand being transferrable between a closed position in which the spout opening and the cap are closed, and an open position in which the spout opening and the cap are open for discharge of the viscous food product, and said cap having a foot so that a stable support is provided for the dispenser in the closed position of the cap;
wherein at least a part of said collar is transparent so that a user can observe said discharge of viscous food product from the spout member.

2. Food dispenser according to claim 1, wherein an annular chamber is defined between the spout member and the collar.

3. Food dispenser according to claim 2, wherein a shield is provided which extends between the spout member and the collar.

4. Food dispenser according to claim 3, wherein the shield is located near or at the lower end of the collar, and the lower end of the spout member protrudes through the shield.

5. Food dispenser according to claim 3, wherein the shield is transparent.

6. Food dispenser according to claim 1, wherein the container comprises a neck, the spout member and/or the collar being detachably connected to the neck.

7. Food dispenser according to claim 1, wherein the bottom opening is closed by means of a releasable seal.

8. Food dispenser according to claim 3, wherein the seal is located between the neck and the spout member.

9. Food dispenser according to claim 1, wherein the cap stand and the spout member are connected to each other by means of a mould seam.

10. Food dispenser according to claim 1, wherein the spout member is non-transparent.

11. Food dispenser according to claim 1, wherein the container is non-transparent.

12. Food dispenser according to claim 1, wherein at least 80% of the collar is transparent.

13. Food dispenser according to claim 1, wherein the cap stand has mutually perpendicular top width dimensions T1, T2 and mutually perpendicular bottom width dimensions B1, B2, at least one of said top width dimensions being smaller than the corresponding bottom width dimension.

14. Food dispenser according to claim 13, wherein the ratio of a bottom width dimension B1, B2 to a corresponding top width dimension T1, T2 of the cap stand is in the range of 2:1 to 1.1:1

15. Food dispenser according to claim 1, wherein the cap comprises an annular flange or rim that engages the bottom end of the collar in the closed position of the cap.

16. Food dispenser according to claim 1, wherein the cap comprises a stop that engages the spout opening in the closed position of said cap.

17. Food dispenser according to claim 1, wherein the spout member (4) protrudes beyond the bottom end of the collar.

18. Food dispenser according to claim 1, wherein an internal width dimension of the bottom end of the collar is at least 2 times larger than an external width dimension of the bottom end of the spout member.

19. Food dispenser according to claim 1, wherein the cap stand has a height dimension H and a bottom width dimension B1, B2, wherein the ratio of said bottom width dimension B1, B2 to height dimension H is in the range of 1:1 to 3:1.

20. Food dispenser according to claim 1, wherein the light transfer capacity of the cap stand material is at least 95%.
